(19) United States
(12) Patent Application Publication
(10) Pub. No.: US 2003/0078708 A1
(43) Pub. Date: Apr. 24, 2003

(54) Productivity and reliability enhancement program

(76) Inventor: David J. Harper, Big Canoe, GA (US)

Correspondence Address: IRVING M. WEINER, WEINER & BURT, P.C., 635 N US-23, P.O. BOX 186, HARRISVILLE, MI, 48740, US

(21) Appl. No.: 10/197,769

(22) Filed: Jul. 17, 2002

Related U.S. Application Data
(60) Provisional application No. 60/330,189, filed on Oct. 18, 2001.

(51) Int. Cl. G06F 17/60

(52) U.S. Cl. 701/29; 705/8

(57) ABSTRACT

A computerized aviation productivity and reliability enhancement program which includes program elements, such as a computerized management information system, computerized inspection flow schedules, a one aircraft at a time program element, a critical path, and a look phase first program element.

The present utility patent application claims priority from U.S. Provisional Patent Application Serial No. 60/330,189 filed Oct. 18, 2001.

The present invention relates generally to a new and useful productivity and reliability enhancement program.

More particularly, the present invention relates to a novel aviation productivity and reliability enhancement program which includes a plurality of program elements, including, but not limited to, a management information system, inspection flow schedules, a one aircraft at a time program element, a critical path, and a look phase first program element.

### BACKGROUND OF THE INVENTION

In the past, various attempts have been made to make improvements in the productivity and quality of aircraft scheduled maintenance. Such attempts have been unsuccessful and have been accompanied by various problems.

The relevant art is exemplified by the following United States Patents:

Sandifer U.S. Pat. No. 5,778,381;

Havens U.S. Pat. 5,909,669;

Chapin, Jr. U.S. Pat. No. 5,931,878; and

Sandifer U.S. Pat. No. 5,987,474.

It is a desideratum of the present invention to avoid the animadversions of the prior art techniques and programs.

### SUMMARY OF THE INVENTION

The present invention provides a new and useful automated aviation productivity and reliability enhancement program, comprising: a computerized management information system; computerized inspection flow schedules operatively interconnected with and responsive to said computerized management information system; a one aircraft at a time program element operatively interconnected with and responsive to said computerized management information system and said computerized inspection flow schedules; a computerized critical path program element operatively interconnected with and responsive to said computerized management information system, said computerized inspection flow schedules, and said one aircraft at a time program element; and a look phase first program element operatively interconnected with and response to said computerized management information system, said computerized inspection flow schedules, and said one aircraft at a time program element; whereby said automated aviation productivity and reliability enhancement program creates significant improvement in productivity and quality of aircraft scheduled maintenance.

The present invention provides a new and useful aviation productivity and reliability enhancement program which includes a plurality of program steps including, but not limited to, a management information system, inspection flow schedules, a one aircraft at a time program element, a critical path, and a look phase first program element.

The primary object of the present invention is to provide a novel productivity and reliability enhancement program as mentioned hereinabove, wherein many of the program elements are automated and/or computerized, as for example, the management information systems, the inspection flow schedules, and the critical path.

Another object of the present new invention is to provide such a program which increases the number of aircraft available for additional flights or an increase in routes.

A further object of the present invention is to reduce the idle effect on aircraft, such as leaking seals, additional corrosion, and ground damage.

Yet a further object of the present invention is to improve FAR (Federal Aviation Regulation) compliance, including records preservation and retrieval systems.

An additional object is to provide such a program which promotes the reduction in accident potential.

Another object of the present invention is to provide such a program which can perform an operational commitment with a reduced number of aircraft.

A further object of the present invention is to provide such a program which reduces the overall requirement for ground support equipment, both powered and non-powered.

The present invention possesses many other advantages and features which will become more apparent to those persons skilled in this area of technology and others upon reading the detailed description of the present invention as set forth hereinbelow.

### DETAILED DESCRIPTION OF THE INVENTION

The aviation productivity and reliability enhancement program in accordance with the present invention is designed to be generic. It will be described hereinbelow for a commercial repair station. However, with a few terminology changes, a novel program can be equally applied to an airline or military maintenance organization.

The crux of the aviation productivity and reliability enhancement program in accordance with the present invention resides in the following program elements: a management information system; inspection flow schedules; a one aircraft at a time program element; a critical path; and a look phase first program element.

The program in accordance with the present invention may optimally also include one or more of the following program elements: a customer survey; program goals; an employee survey; spares management; a refined prioritization system; a quality assurance inspection; and a human factors review.

The key elements of the program which lend themselves to automation and computerization are the management information system, the inspect flow schedules, and the critical path.

In accordance with the invention, a management information system will be maintained for total control of each aircraft process. The management information system is critical to timely process the flow of the aircraft. If the correct status is known at all times, resources (i.e., manpower, spares, support equipment, hangar space, etc.) can be better directed and re-directed when needed. Critical paths can be adjusted. Increased customer confidence will be a by-product.

Another essential element of the present invention are the inspection flow schedules. An inspection flow schedule should be created and followed for each aircraft. In the past, there has been a tendency to use the same schedule templates repeatedly for each aircraft. While a template can be useful, it often does not account for individual, specific needs of each aircraft.

The goal of the inspection flow schedule according to the present invention is to: avoid surprises; make best use of manpower; have all needed spares on hand; and schedule test equipment, hangar space and all other resources.

Another important element of the present invention is the one aircraft at a time program element. In the past, there has been a tendency to expand the calendar time, the number of shifts, and the number of lines used to process heavy check aircraft. This has been caused by several factors, including: increases in the size and complexity of aircraft; aging aircraft requiring more maintenance; inadequate or erratic spares availability; and the desire to support customers with flexibility in scheduling. This tendency to expand has worked against the industry. It has caused the industry to spread resources so thinly that industry cannot process any aircraft effectively.

In contrast, in accordance with the present invention, and especially the one aircraft at a time program element, all support and test equipment, all spares, and all management attention will be focused intensely on one aircraft at a time.

Another important element of the present invention relates to the critical path program element. The goal is to provide a scheduling method to be used which ensures the most rapid, optimal flow of the aircraft through inspection.

In the past, a significant number of operations have had conflicting events. For example, work had to stop while the aircraft is being jacked or while x-rays are being taken, or while critical flight control rigging is being performed. The purpose of the critical path program element of the present invention is to make sure that work is pre-planned to be non-conflicting. At the same time, all other work should be scheduled to be accomplished during a single one-shift operation each day.

The critical path program element ensures that all events are accounted for and that all conflicting work (x-ray, fuel cell, paint, rigging, etc.) is moved to non-conflicting times. Additional work can be encouraged if it does not interfere with the flow of the inspection.

Another essential program element of the present invention is the look phase first program element. The goal of the look phase first program element is for work flow to be organized to minimize flow time on the aircraft.

In the past, the “look-fix” sequencing of work caused discrepancies to be found late in the flow, caused parts requirements to be unknown until late in the scheduled flow time; provided more opportunity for errors in documentation; provided more opportunity for work interruptions; and provided insufficient information to properly manage the aircraft through inspection.

In accordance with the present invention, it has been found that the best alternative is to conduct the entire look phase first, document all discrepancies, and order all parts prior to beginning the fix phase. Data on the complete, correct status of the aircraft can then be captured in the management information system. Visibility of long lead items can then be known and can be more easily managed.

The aviation productivity and reliability enhancement program in accordance with the present invention is designed to create significant improvement in the productivity and the quality of aircraft scheduled maintenance. It can be described as a combination of the best aviation maintenance strategy, process, technology, and people, with critical program elements being automated and/or computerized.

There has been described hereinabove only one unique and novel preferred embodiment of the present invention which can be implemented in many different configurations, and arrangements of program elements. It should be understood that many changes, modifications, variations, and other uses and applications will become apparent to those persons skilled in this particular area of technology and to others after having been exposed to the present patent application.

Any and all such changes, modifications, variations and other uses and applications which do not depart from the spirit and scope of the present invention are therefore covered by and embraced within the present invention and patent application.

1. An automated aviation productivity and reliability enhancement program, comprising:
a computerized management information system;
computerized inspection flow schedules operatively interconnected with and responsive to said computerized management information system;
a one aircraft at a time program element operatively interconnected with and responsive to said computerized management information system and said computerized inspection flow schedules;
a computerized critical path program element operatively interconnected with and responsive to said computerized management information system, said computerized inspection flow schedules, and said one aircraft at a time program element; and
a look phase first program element operatively interconnected with and responsive to said computerized management information system, said computerized inspection flow schedules, and said one aircraft at a time program element;
whereby said automated aviation productivity and reliability enhancement program creates significant improvement in productivity and quality of aircraft scheduled maintenance.

2. An automated aviation productivity and reliability enhancement program in accordance with claim 1, wherein:
said look phase first program element organizes work flow for an aircraft to minimize flow time on said aircraft.

3. An automated aviation productivity and reliability enhancement program in accordance with claim 1, including;
a customer survey program element operatively interconnected with said computerized management information system, said computerized inspection flow schedules, said one aircraft at a time program element, and said look phase first program element.

4. An automated aviation productivity and reliability enhancement program in accordance with claim 2, including;
a customer survey program element operatively interconnected with said computerized management information system, said computerized inspection flow schedules, said one aircraft at a time program element, and said look phase first program element.

5. An automated aviation productivity and reliability enhancement program in accordance with claim 1, including;
a program goals program element operatively interconnected with said computerized management information system, said computerized inspection flow schedules, said one aircraft at a time program element, and said look phase first program element.

6. An automated aviation productivity and reliability enhancement program in accordance with claim 2, including;
a program goals program element operatively interconnected with said computerized management information system, said computerized inspection flow schedules, said one aircraft at a time program element, and said look phase first program element.

7. An automated aviation productivity and reliability enhancement program in accordance with claim 3, including;
a program goals program element operatively interconnected with said computerized management information system, said computerized inspection flow schedules, said one aircraft at a time program element, and said look phase first program element.

8. An automated aviation productivity and reliability enhancement program in accordance with claim 4, including;
a program goals program element operatively interconnected with said computerized management information system, said computerized inspection flow schedules, said one aircraft at a time program element, and said look phase first program element.

9. An automated aviation productivity and reliability enhancement program in accordance with claim 1, including;
a quality assurance inspection program element operatively interconnected with said computerized management information system, said computerized inspection flow schedules, said one aircraft at a time program element, and said look phase first program element.

10. An automated aviation productivity and reliability enhancement program in accordance with claim 2, including;
a quality assurance inspection program element operatively interconnected with said computerized management information system, said computerized inspection flow schedules, said one aircraft at a time program element, and said look phase first program element.

11. An automated aviation productivity and reliability enhancement program in accordance with claim 1, including;
a refined prioritization system program element operatively interconnected with said computerized management information system, said computerized inspection flow schedules, said one aircraft at a time program element, and said look phase first program element.

12. An automated aviation productivity and reliability enhancement program in accordance with claim 2, including;
a refined prioritization system program element operatively interconnected with said computerized management information system, said computerized inspection flow schedules, said one aircraft at a time program element, and said look phase first program element.

13. An automated aviation productivity and reliability enhancement program in accordance with claim 1, including;
a spares management program element operatively interconnected with said computerized management information system, said computerized inspection flow schedules, said one aircraft at a time program element, and said look phase first program element.

14. An automated aviation productivity and reliability enhancement program in accordance with claim 2, including;
a spares management program element operatively interconnected with said computerized management information system, said computerized inspection flow schedules, said one aircraft at a time program element, and said look phase first program element.

15. An automated aviation productivity and reliability enhancement program in accordance with claim 1, including;
a human factors review program element operatively interconnected with said computerized management information system, said computerized inspection flow schedules, said one aircraft at a time program element, and said look phase first program element.

16. An automated aviation productivity and reliability enhancement program in accordance with claim 2, including;
a human factors review program element operatively interconnected with said computerized management information system, said computerized inspection flow schedules, said one aircraft at a time program element, and said look phase first program element.

17. An automated aviation productivity and reliability enhancement program in accordance with claim 1, wherein:
said computerized management information system maintains total control of each aircraft process, and directs and re-directs when needed resources, such as manpower, spare parts, support equipment, and hangar space.

18. An automated aviation productivity and reliability enhancement program in accordance with claim 2, wherein:
said computerized management information system maintains total control of each aircraft process, and directs and re-directs when needed resources, such as manpower, spare parts, support equipment, and hangar space.

19. An automated aviation productivity and reliability enhancement program in accordance with claim 9, wherein:
said computerized management information system maintains total control of each aircraft process, and directs and re-directs when needed resources, such as manpower, spare parts, support equipment, and hangar space.

20. An automated aviation productivity and reliability enhancement program in accordance with claim 1, including;
an employee survey program element operatively interconnected with said computerized management information system, said computerized inspection flow schedules, said one aircraft at a time program element, and said look phase first program element.
